(19) United States
(12) Patent Application Publication
(10) Pub. No.: US 2026/0021982 A1
(43) Pub. Date: Jan. 22, 2026

(54) MEDIUM CONVEYING APPARATUS

(71) Applicant: PFU LIMITED, Kahoku-shi (JP)

(72) Inventor: Shinya Orita, Kahoku-shi (JP)

(21) Appl. No.: 19/263,187

(22) Filed: Jul. 8, 2025

(30) Foreign Application Priority Data
Jul. 18, 2024 (JP) 2024-115158

(51) Int. Cl. B65H 1/02; H04N 1/00

(52) U.S. Cl. CPC B65H 1/02; H04N 1/00623; B65H 2402/31; B65H 2405/21; B65H 2801/39

(57) ABSTRACT

A medium conveying apparatus includes a first media tray including a first media placement surface, a second media tray located above the first media tray and having a second media placement surface, and a third media tray located above the second media tray and having a third media placement surface. A width of the second media placement surface in an intersecting direction intersecting a medium conveying direction and a width of the third media placement surface in the intersecting direction are smaller than a width of the first media placement surface in the intersecting direction, and the third media tray is swingable relative to the second media tray in accordance with an amount of media placed on the second media placement surface.

### CROSS-REFERENCE TO RELATED APPLICATIONS

This patent application is based on and claims priority pursuant to 35 U.S.C. § 119(a) to Japanese Patent Application No. 2024-115158, filed on Jul. 18, 2024, in the Japan Patent Office, the entire disclosure of which is hereby incorporated by reference herein.

### BACKGROUND

The present disclosure relates to a medium conveying apparatus.

Medium conveying apparatuses, such as a scanner and a printer, that convey a medium are desired to convey media different in width. To convey media different in width, some medium conveying apparatuses include multiple media trays having media placement surfaces different in width.

A document feeder includes a first media tray including a first media placement surface, a second media tray including a second media placement surface, and a third media tray including a third media placement surface.

### SUMMARY

The medium conveying apparatus according to one aspect of the present disclosure includes a first media tray including a first media placement surface, a second media tray located above the first media tray and including a second media placement surface, and a third media tray located above the second media tray and including a third media placement surface. A width of the second media placement surface in an intersecting direction intersecting a medium conveying direction and a width of the third media placement surface in the intersecting direction are smaller than a width of the first media placement surface in the intersecting direction, and the third media tray is swingable relative to the second media tray in accordance with an amount of media placed on the second media placement surface.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a medium conveying apparatus according to an embodiment;

FIG. 2A is a perspective view of a medium guide as viewed from obliquely above;

FIG. 2B is a front view of the medium guide as viewed from the front side;

FIG. 3 is a perspective view of a guide body as viewed obliquely from above;

FIG. 4A is a perspective view of the medium guide as viewed from below and from downstream;

FIG. 4B is a perspective view of a second media tray and a third media tray as viewed from obliquely below and from downstream;

FIG. 5 is a schematic diagram for explaining the position of a swing part;

FIG. 6A is a schematic diagram for explaining the position of the third media tray;

FIG. 6B is a diagram illustrating the third media tray restricted in swing by stoppers;

FIG. 7 is a diagram illustrating a media tray, the second tray, and the third media tray on which media are placed;

FIG. 8 is a perspective view of the third media tray for explaining the overlap between a third sidewall of the third media tray and a restricting portion;

FIG. 9 is a perspective view of a hinge to which a leg is attached;

FIG. 10A is a schematic diagram illustrating the medium guide being stored in conjunction with the media tray;

FIG. 10B is a schematic diagram illustrating the medium guide stored in conjunction with the media tray;

FIG. 11 is a diagram for explaining a medium conveying path inside the medium conveying apparatus;

FIG. 12 is a block diagram illustrating a schematic configuration of the medium conveying apparatus;

FIG. 13 is a block diagram illustrating schematic configurations of a memory and a processing circuit;

FIG. 14 is a flowchart of a medium conveying process;

FIG. 15A is a perspective view of a medium guide according to another embodiment, as viewed from obliquely above;

FIG. 15B is a perspective view of a guide body of the medium guide illustrated in FIG. 15A, as viewed obliquely from above; and

FIG. 16 is a block diagram illustrating a schematic configuration of another processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A medium conveying apparatus according to embodiments of the present disclosure will be described below with reference to the drawings. The technical scope of the present disclosure is not limited to the embodiments described below and covers equivalents of elements described below.

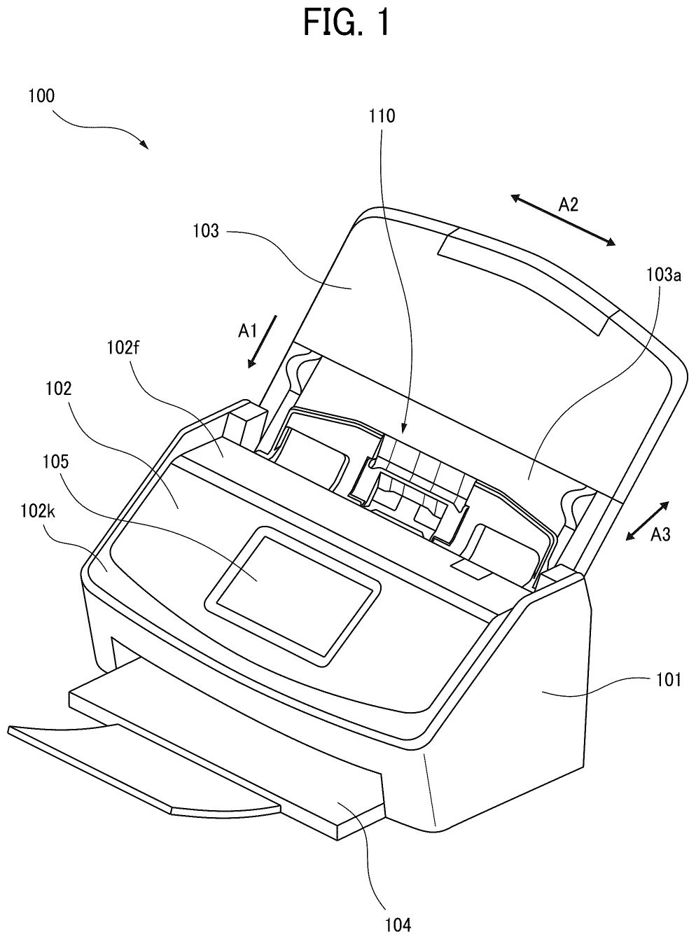

FIG. 1 is a perspective view of a medium conveying apparatus 100 that is an image scanner.

The medium conveying apparatus 100 conveys, images, and ejects media that are documents. Examples of the media include paper, thin paper, thick paper, a card, a booklet, and a passport. The media includes three or more different media different in width. The medium conveying apparatus 100 may be a facsimile machine, a copier, or a multifunction peripheral (MFP).

In FIG. 1, arrow A1 indicates the medium conveying direction, arrow A2 indicates the width direction perpendicular to the medium conveying direction A1, and arrow A3 indicates the height direction perpendicular to the medium conveying direction A3. In the following, upstream is upstream in the medium conveying direction A1, and downstream is downstream in the medium conveying direction A1. The upper side is the upper side in the height direction A3, and the lower side is the lower side in the height direction A3.

The medium conveying apparatus 100 includes a lower housing 101, an upper housing 102, a media tray 103, an ejection tray 104, a display and operation device 105, and a medium guide 110.

The lower housing 101 and the upper housing 102 are made of, for example, a resin material, and cover the inside of the medium conveying apparatus 100. The upper housing 102 covers the upper side of the medium conveying apparatus 100 and is hinged to the lower housing 101 to open and close, for example, to remove a jammed medium or clean the inside of the medium conveying apparatus 100. The upper housing 102 includes an inclined face 102k provided with the display and operation device 105, and a flat lid 102f.

The media tray 103 is an example of a first media tray. The media tray 103 is made of, for example, a resin material, engages with the lower housing 101, and is rotatable by the hinge. When the medium conveying apparatus 100 is not used, the media tray 103 is located to cover the lower housing 101 and the upper housing 102 and functions as an exterior cover. When the medium conveying apparatus 100 is used, the media tray 103 is located at such a position that media to be fed and conveyed can be placed thereon. In the following description, the position at which the media tray 103 covers the upper housing 102 and the lower housing 101 may be referred to as a stored position, and the position at which the media tray 103 receives a medium may be referred to as an in-use position. The media tray 103 is swingable in the medium conveying direction A1 to move between the in-use position and the stored position.

The media tray 103 includes a first media placement surface 103a on which media are placed. The first media placement surface 103a has such a width that, for example, an A3-size or A4-size medium is placed with the longitudinal direction thereof aligned in the medium conveying direction A1.

The ejection tray 104 is engaged with the lower housing 101, and the ejected media are placed thereon. The ejection tray 104 may be engaged with the upper housing 102 with, for example, a hinge.

The display and operation device 105 includes a display and an interface circuit that outputs image data to the display, and displays the image data on the display. Examples of the display include a liquid crystal display and an organic electro-luminescence (EL) display. The display and operation device 105 further includes a touch-screen input device and an interface circuit that receives signals from the input device. The display and operation device 105 receives an input operation performed by a user and outputs an operation signal corresponding to the input operation performed by the user. The medium conveying apparatus 100 may include a display device and an operation device separately.

The medium guide 110 is located above the first media placement surface 103a of the media tray 103.

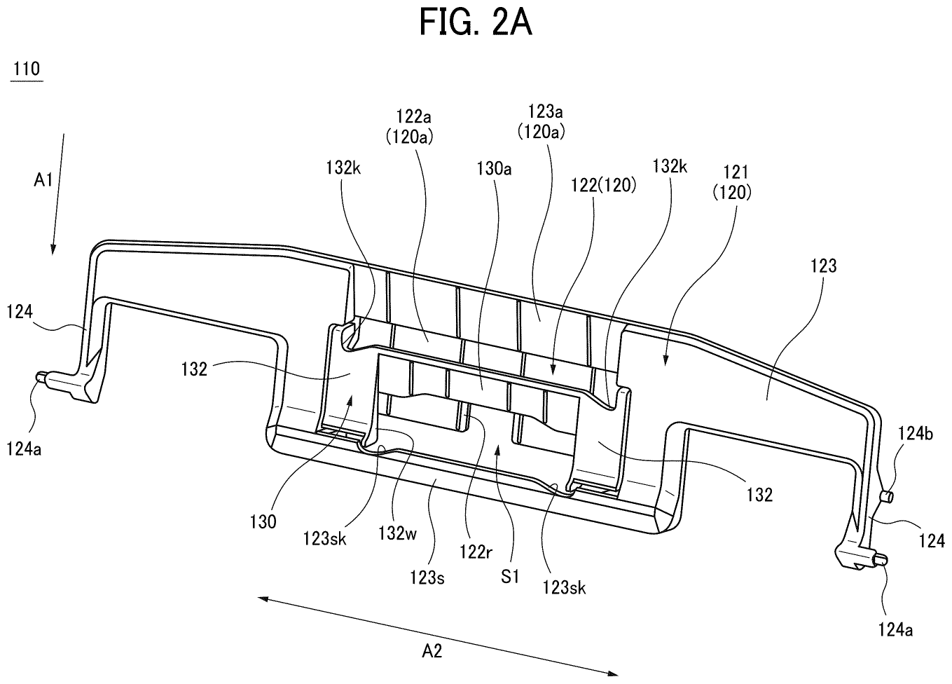

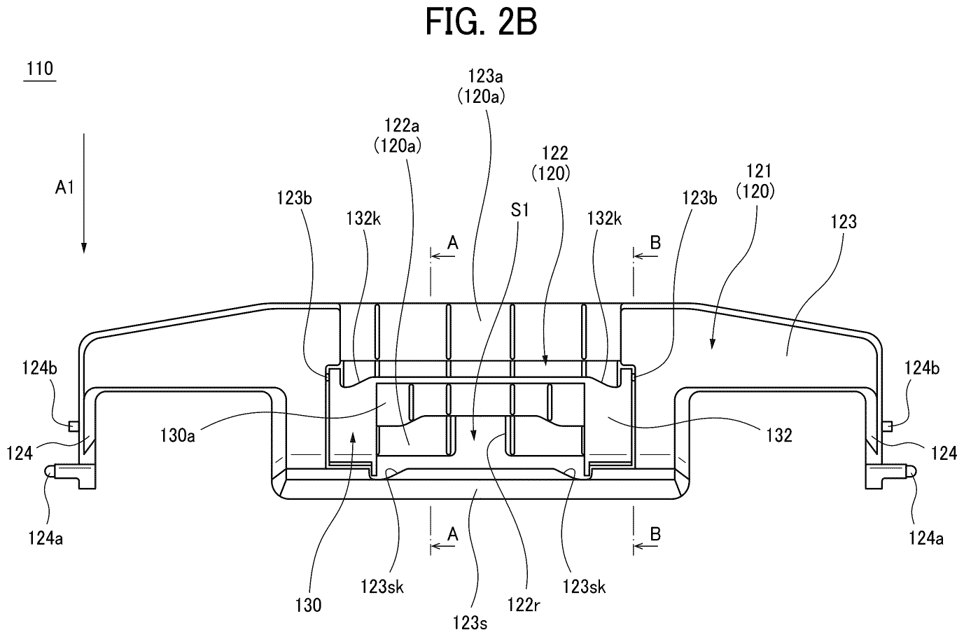

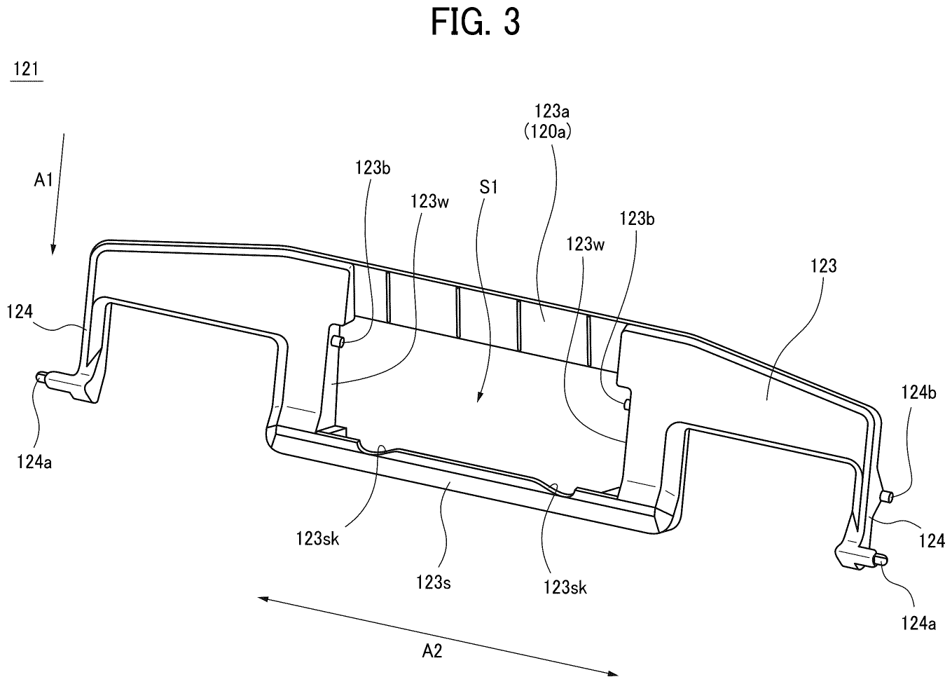

FIG. 2A is a perspective view of the medium guide 110 detached from the media tray 103, as viewed from obliquely above. FIG. 2B is a front view of the medium guide 110 detached from the media tray 103, as viewed from the front. FIG. 3 is a perspective view of a guide body 121 of the medium guide 110 as viewed obliquely from above.

The medium guide 110 includes a second media tray 120 and a third media tray 130.

The second media tray 120 includes a second media placement surface 120a on which media are placed. The second media tray 120 includes a guide body 121 and a swing part 122.

The guide body 121 of the second media tray 120 is made of, for example, a resin material. The guide body 121 includes a main body 123 and legs 124. The main body 123 is plate shaped and extends in the width direction A2. The main body 123 has a rectangular opening S1 for attaching the swing part 122 and the third media tray 130 at the center thereof.

In the main body 123, a first introducing face 123a is located in the center area in the width direction A2 and upstream from the opening S1 in the medium conveying direction A1. The first introducing face 123a is a part of the second media placement surface 120a. The first introducing face 123a is inclined such that the downstream end is located below the upstream end, and guides the medium to the swing part 122. The first introducing face 123a is narrower than the first media placement surface 103a in the width direction A2. The second media tray 120 is suitable for a medium having a width smaller than that of the medium placed on the media tray 103. Since the medium conveying apparatus 100 includes the second media tray 120 separately from the media tray 103, the medium conveying apparatus 100 can properly convey media different in width.

The main body 123 includes two first sidewalls 123w at both ends of the opening S1 in the width direction A2. The two first sidewalls 123w are erected to face each other and extend from the upstream side to the downstream side. In the upstream portions of the first sidewalls 123w, two swing shafts 123b are located and face each other in the width direction A2. The two swing shafts 123b are swing fulcrums that support the third media tray 130 to swing.

The main body 123 further includes a restricting portion 123s located downstream from the opening S1 in the medium conveying direction A1 and in the central portion in the width direction A2. The restricting portion 123s is plate shaped and located parallel to the first introducing face 123a. The restricting portion 123s guides the medium placed on the second media placement surface 120a or a third media placement surface 130a downstream while restricting the medium from floating.

The restricting portion 123s includes two first cutout portions 123sk located in the upstream portion in the medium conveying direction A1. Each first cutout portion 123sk is located in the end portion in the width direction A2 and cut out in a substantially trapezoidal shape in plan view from the upstream side to the downstream side. The two first cutout portions 123sk are located to face the third media placement surface 130a of the third media tray 130. The first cutout portions 123sk of the restricting portion 123s give spaces for an end portion of the medium to escape when the end portion of the medium on the third media placement surface 130a is folded or bent.

The legs 124 extend downstream from both ends of the main body 123 in the width direction A2. At the distal end of each leg 124, a swing shaft 124a projects outward in the width direction A2. Each leg 124 further includes a slide shaft 124b located upstream from the swing shaft 124a and below the swing shaft 124a. The swing shaft 124a serves as the swing fulcrum of the guide body 121.

The swing part 122 is made of, for example, a resin material. The swing part 122 is located in the opening S1, that is, downstream from the first introducing face 123a of the main body 123 and swingable relative to the main body 123. The swing fulcrum of the swing part 122 is located at the upstream end of the swing part 122. The upstream portion of the swing part 122 is located below the first introducing face 123a and is covered with the first introducing face 123a. The downstream portion of the swing part 122 is not covered with the first introducing face 123a but is exposed.

The swing part 122 is a plate-like member having a rectangular shape in plan view. In the swing part 122, a second introducing face 122a that is a part of the second media placement surface 120a is located. The second introducing face 122a introduces the medium to the downstream side. The length of the second introducing face 122a in the width direction A2 is equal to or smaller than the length of the first introducing face 123a in the width direction A2. In other words, the length of the second introducing face 122a in the width direction A2 is smaller than the length of the first media placement surface 103a in the width direction A2.

The third media tray 130 is made of, for example, a resin material. The third media tray 130 has a substantially inverted U shape in plan view. The third media tray 130 is located at the opening S1, that is, downstream from the swing part 122 and above the swing part 122.

The third media tray 130 includes a third media placement surface 130a and arms 132. The third media placement surface 130a is inclined such that the downstream end is located below the upstream end, and guides the medium downstream. The length of the third media placement surface 130a in the width direction A2 is smaller than the length of the second media placement surface 120a (the first introducing face 123a and the second introducing face 122a) in the width direction A2. In other words, the length of the third media placement surface 130a in the width direction A2 is smaller than the length of the first media placement surface 103a in the width direction A2. The third media tray 130 is suitable for a medium having a width smaller than that of the medium placed on the media tray 103 or the second media tray 120. Since the medium conveying apparatus 100 includes the third media tray 130 separately from the media tray 103 and the second media tray 120, the medium conveying apparatus 100 can properly convey media different in width.

The arms 132 are substantially rectangular in plan view, and extend downstream from both ends of the third media placement surface 130a in the width direction A2. The arms 132 are integral with the third media placement surface 130a.

Each arm 132 includes a second cutout portion 132k located at the upstream end in the medium conveying direction A1 and in the outer end portion in the width direction A2. Each second cutout portion 132k is cut out in a substantially trapezoidal shape in plan view from the upstream side to the downstream side. The two second cutout portions 132k are located to face the second media placement surface 120a of the second media tray 120. The second cutout portions 132k of the arm 132 give spaces for the end portions of the medium to escape when a medium having folded or bent end portions is placed on the second media placement surface 120a.

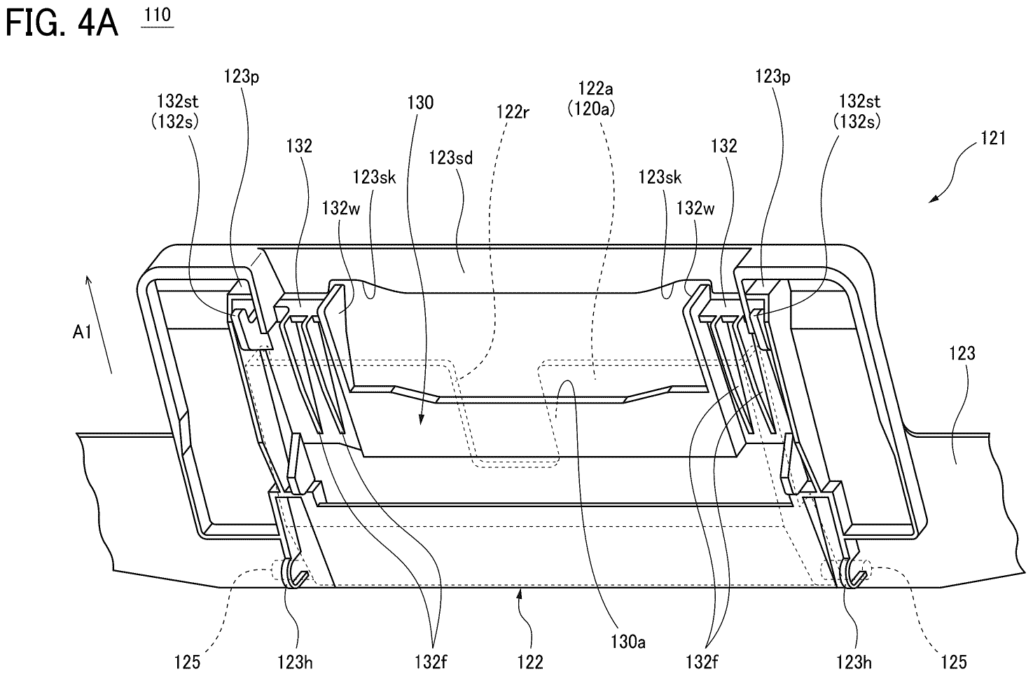

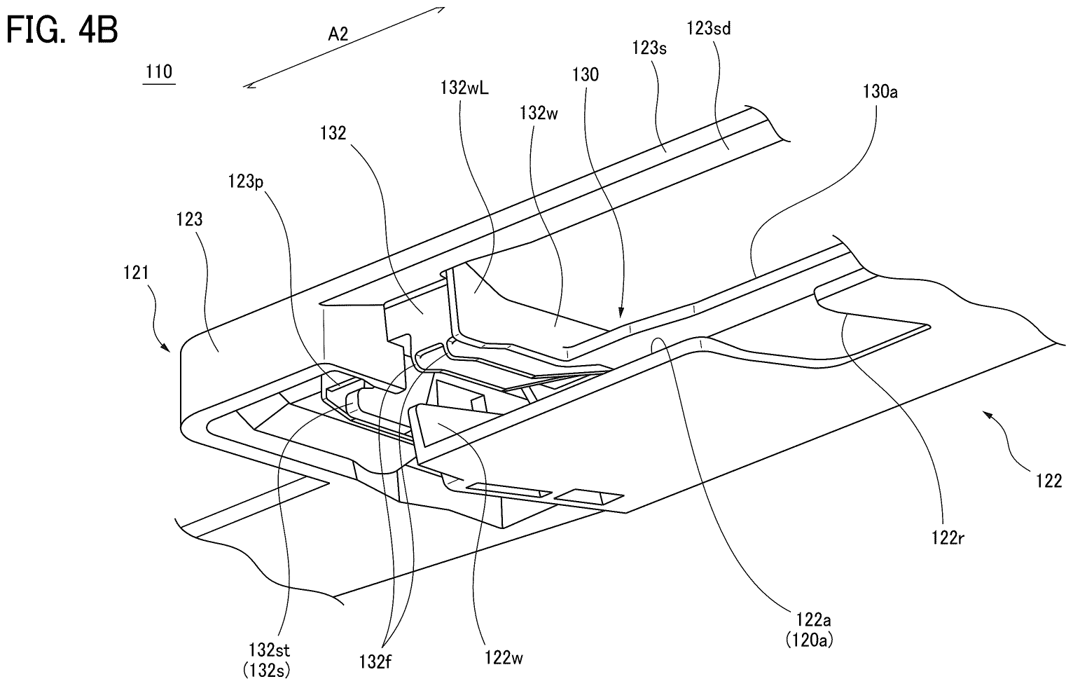

FIG. 4A is a perspective view of the medium guide 110 as viewed from below and the downstream side. FIG. 4B is a perspective view of the second media tray 120 and the third media tray 130 as viewed from obliquely below and the downstream side.

As illustrated in the FIG. 4A, a swing shaft 125 projects outward from each end in the width direction A2 of the upstream portion of the swing part 122 (indicated by a broken line) of the second media tray 120. On the back side of the main body 123, shaft supports 123h that support the swing shaft 125 are located at the upstream end and at the positions facing the swing shaft 125.

By the swing shaft 125 attached to and supported by the shaft supports 123h, the swing part 122 is swingable with the upstream portion of the swing part 122 being the swing fulcrum. In other words, the swing part 122 is swingable relative to the guide body 121. When the swing shaft 125 is detached from the shaft supports 123h, the swing part 122 is detached from the main body 123.

As illustrated in the FIG. 4B, the second media tray 120 includes two second sidewalls 122w located at both ends of the swing part 122 in the width direction A2. The two second sidewalls 122w are erected to face each other and extend from the upstream side to the downstream side. The two second sidewalls 122w function as side guides that align the media placed on the second media tray 120 in the width direction A2. The medium conveying apparatus 100 can properly convey the media placed on the second media placement surface 120a while preventing the media from tilting by the second sidewalls 122w. At the center of the swing part 122 in the width direction A2, a recess 122r is formed and open on the downstream side.

As illustrated in FIGS. 4A and 4B, the lower face 123sd of the restricting portion 123s in the guide body 121 is inclined such that the downstream end is located below the upstream end. The restricting portion 123s restricts the floating of the medium placed on the second media placement surface 120a of the second media tray 120 or the medium placed on the third media placement surface 130a of the third media tray 130. Accordingly, the medium conveying apparatus 100 can prevent the floating of the medium placed on the second media placement surface 120a of the second media tray 120 or the medium placed on the third media placement surface 130a of the third media tray 130, and properly convey the medium.

The third media tray 130 includes two third sidewalls 132w located at both ends of the third media placement surface 130a in the width direction A2 intersecting the medium conveying direction A1. The third sidewalls 132w are examples of a sidewall. The two third sidewalls 132w are erected to face each other and extend from the upstream side to the downstream side. The two third sidewalls 132w are inclined such that the downstream ends are located above the upstream ends. The two third sidewalls 132w function as side guides that align the media placed on the third media tray 130 in the width direction A2. The medium conveying apparatus 100 can properly convey media placed on the third media placement surface 130a while preventing the media from tilting by the third sidewalls 132w.

On the back face of each arm 132 of the third media tray 130, two thin restricting plates 132f extend in the medium conveying direction A1 parallel to the third sidewalls 132w. The restricting plates 132f are ribs projecting downward beyond the third sidewalls 132w. The restricting plates 132f restrict the floating of the media placed on the second media placement surface 120a of the second media tray 120.

Each arm 132 includes a projecting portion 132s on the back face. The projecting portion 132s is located outer than the third sidewall 132w in the width direction A2. The downstream end of the projecting portion 132s includes a projecting end 132st. The second media tray 120 includes stoppers 123p. The stoppers 123p are located corresponding to the projecting ends 132st of the projecting portion 132s on the back side of the main body 123 of the guide body 121. The stoppers 123p restrict the upward swinging of the downstream end of the third media tray 130 in the medium conveying direction A1. The stoppers 123p prevent the third media placement surface 130a from being positioned above the restricting portion 123s, thereby preventing damage to the media placed on the third media placement surface 130a.

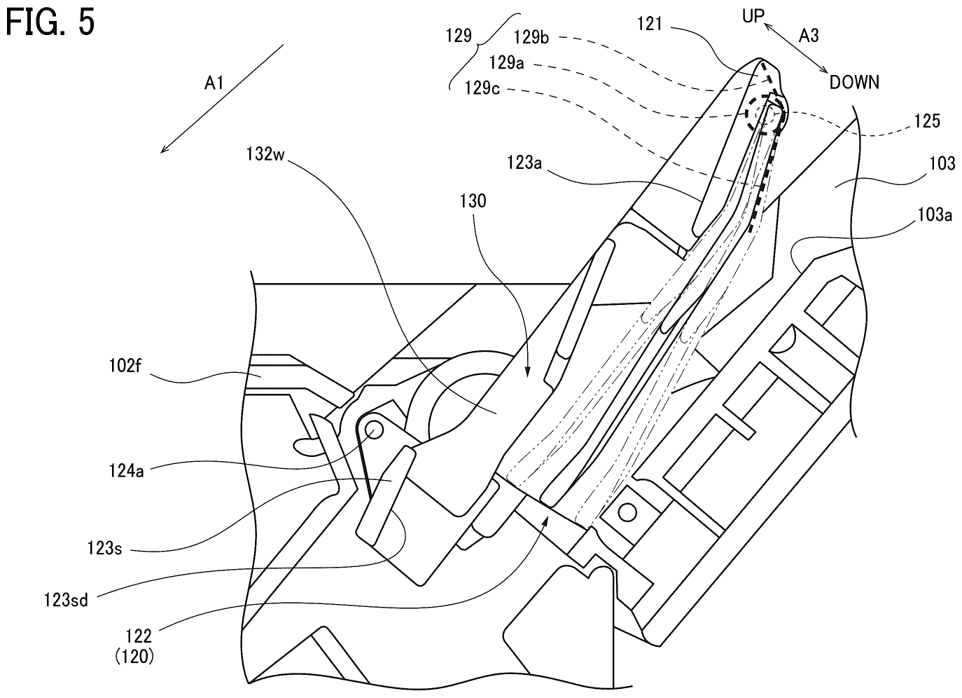

FIG. 5 is a schematic diagram for explaining the position of the swing part 122.

As illustrated in FIG. 5, the swing part 122 is swingable about the swing shaft 125. In particular, the swing part 122 is swingable upward relative to the media tray 103 in accordance with the amount of media placed on the first media placement surface 103a of the media tray 103. The amount of media includes the weight and the bulk (height) of the placed media in total. In other words, the swing part 122 swings upward by the height corresponding to the amount of media placed on the first media placement surface 103a. This enables the user to flexibly change the amount of media placed on the media tray 103 and the amount of media placed on the second media tray 120. Accordingly, the medium conveying apparatus 100 can flexibly change the mode of the media tray 103 according to the purpose of the user and can enhance user convenience.

Further, the swing part 122 is swingable downward in accordance with the amount of media placed on the second media placement surface 120a. In other words, the swing part 122 swings downward by the height corresponding to the amount of media placed on the second media placement surface 120a. This enables users to flexibly change the amount of media placed on the media tray 103 and the amount of media placed on the second media placement surface 120a. In particular, even when the third media tray 130 is swung downward due to a large amount of media placed on the third media placement surface 130a, the user can swing the swing part 122 downward and place a certain amount of media on the second media placement surface 120a. Accordingly, the medium conveying apparatus 100 can flexibly change the mode of the media tray 103 according to the purpose of the user and can enhance user convenience.

The range of swing of the swing part 122 about the swing shaft 125 extends from the lower position where the swing part 122 contacts the media tray 103 (the first media placement surface 103a) to the upper position where the swing part 122 contacts the third media tray 130.

When the swing part 122 is at the position to contact the third media tray 130, a large amount of media can be placed on the first media placement surface 103a. By contrast, when the swing part 122 is at the position to contact the media tray 103, a large amount of medium can be placed on the swing part 122 and the third media tray 130.

A torsion coil spring 129 that biases the swing part 122 is attached to the swing shaft 125 of the main body 123. The torsion coil spring 129 includes a coil portion 129a, a first leg 129b, and a second leg 129c. The coil portion 129a is fixed to the swing shaft 125, the first leg 129b is fixed to the guide body 121, and the second leg 129c contacts the lower face of the swing part 122. The spring force of the torsion coil spring 129 is set in advance such that the second media tray 120 swings upward when a first predetermined amount or more of media are placed on the first media placement surface 103a, and the second media tray 120 swings downward when a second predetermined amount or more of media are placed on the second media placement surface 120a. The first predetermined amount and the second predetermined amount are determined based on the amount of media that can be placed on the first media placement surface 103a and the amount of media that can be placed on the second media placement surface 120a, respectively.

In the initial state in which no medium is placed on the first media placement surface 103a, the second media placement surface 120a, and the third media placement surface 130a, the swing part 122 is positioned at an intermediate position of the swing range by the spring force of the torsion coil spring 129. Accordingly, the swing part 122 is swingable upward or downward from the position in the initial state. In particular, the second media tray 120 is swingable downward from the position in the initial state. Further, the second media tray 120 is swingable downward when the amount of media placed on the second media placement surface 120a is equal to or more than the predetermined amount. Accordingly, the medium conveying apparatus 100 can automatically position the second media tray 120 at an appropriate position in accordance with the amount of media placed on the second media tray 120 or the amount of media placed on the third media tray 130. Accordingly, the medium conveying apparatus 100 can enhance user convenience.

The position of the swing part 122 in the initial state may be the highest position or the lowest position within the swing range.

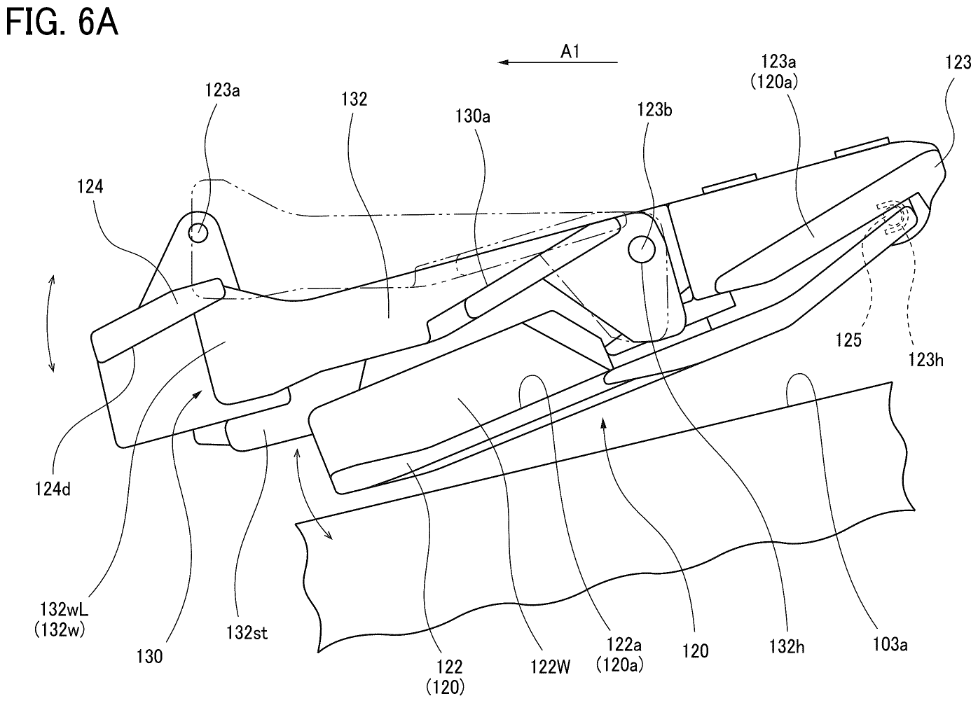

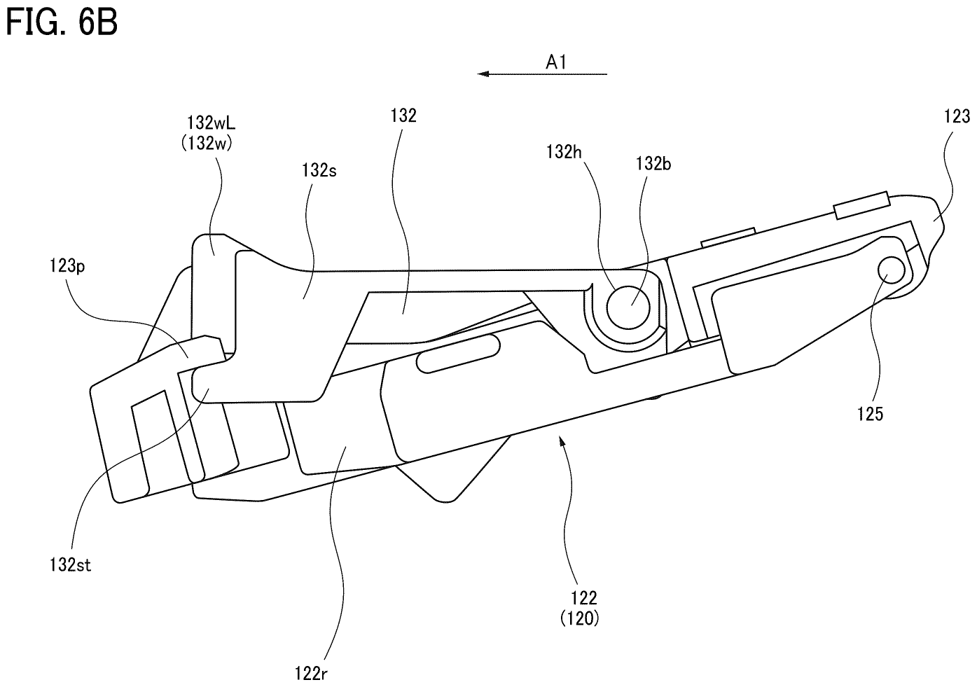

FIG. 6A is a schematic diagram for explaining the position of the third media tray 130. FIG. 6A is a sectional view of the medium guide 110 taken along line A-A in FIG. 2B. FIG. 6B is a schematic diagram illustrating the third media tray 130 restricted by the stopper 123p. FIG. 6B is a sectional view of the medium guide 110 taken along line B-B in FIG. 2B.

At the upstream end of the outer end face of the arm 132 of the third media tray 130 in the width direction A2, a bottomed columnar hole 132h is located. The third media tray 130 is swingably attached to the main body 123 when the swing shaft 123b of the main body 123 is fitted into the hole 132h in the third media tray 130. Accordingly, the third media tray 130 is swingable with the swing shaft 123b of the main body 123 and the hole 132h of the arm 132 as swing fulcrums.

In particular, the third media tray 130 is swingable upward relative to the second media tray 120 in accordance with the amount of media placed on the second media placement surface 120a of the second media tray 120. In other words, the third media tray 130 swings upward by the height corresponding to the amount of media placed on the second media placement surface 120a. This enables the user to flexibly change the amount of media placed on the second media tray 120 and the amount of media placed on the third media tray 130. In particular, even when the second media tray 120 is swung upward due to a large amount of media placed on the first media placement surface 103a, the user can swing the third media tray 130 upward and place a certain amount of media on the second media placement surface 120a. Accordingly, the medium conveying apparatus 100 can flexibly change the mode of the media tray 103 according to the purpose of the user and can enhance user convenience.

The third media tray 130 is swingable downward relative to the second media tray 120 in accordance with the amount of media placed on the third media placement surface 130a. In other words, the third media tray 130 swings downward by the height corresponding to the amount of media placed on the third media placement surface 130a. This enables the user to flexibly change the amount of media placed on the second media tray 120 and the amount of media placed on the third media tray 130. Accordingly, the medium conveying apparatus 100 can flexibly change the mode of the media tray 103 according to the purpose of the user and can enhance user convenience.

The swing fulcrum of the third media tray 130 is located at the upstream end of the third media tray 130 in the medium conveying direction A1. Since the downstream end of the third media tray 130 swings, the user can easily place media on the third media tray 130. Thus, the medium conveying apparatus 100 can enhance user convenience.

The swing shaft 123b, which is the swing fulcrum of the third media tray 130, is located outer than the second media placement surface 120a of the second media tray 120 located in the opening S1 of the main body 123 in the width direction A2 intersecting the medium conveying direction A1. As a result, the media placed on the second media placement surface 120a of the second media tray 120 are conveyed properly without being blocked by the swing shaft 123b of the third media tray 130.

The third media tray 130 is swingable upward or downward from the position in the initial state in which no medium is placed on the first media placement surface 103a, the second media placement surface 120a, and the third media placement surface 130a. The downward swing of the third media tray 130 is restricted by the contact between the restricting plate 132f (FIGS. 4A and 4B) of the arm 132 and the second introducing face 122a of the swing part 122. By contrast, the upward swing of the third media tray 130 is restricted by the contact between the projecting end 132st of the projecting portion 132s and the stopper 123p of the main body 123. The highest position in the swing range of the third media tray 130 is set to the position where the medium placed on the third media placement surface 130a can be conveyed to the medium conveying path.

The restricting portion 123s is located to face the third media placement surface 130a when the third media tray 130 swings to the highest position. The medium placed on the third media placement surface 130a contacts the lower face 123sd of the restricting portion 123s and is conveyed along the lower face 123sd of the restricting portion 123s. In this manner, the restricting portion 123s reliably guides the medium placed on the third media placement surface 130a to the opening of the medium conveying apparatus 100.

The position of the third media tray 130 in the initial state may be the highest position or the lowest position within the swing range.

When the swing shaft 123b is detached from the hole 132h, the third media tray 130 is detached from the medium guide 110. In this manner, the third media tray 130 is attachable to and detachable from the medium guide 110.

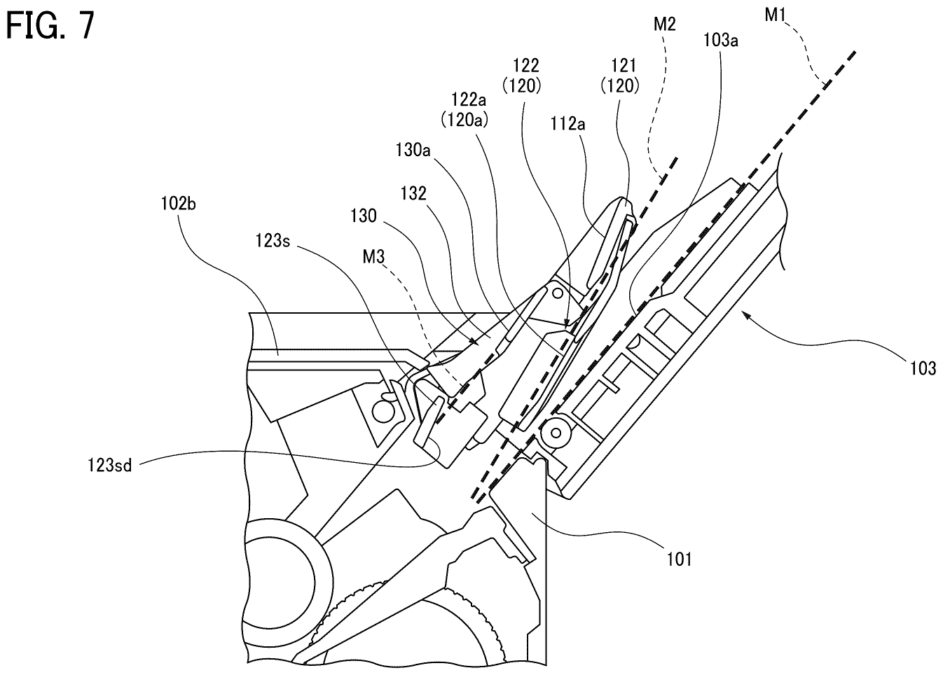

FIG. 7 is a diagram for explaining a state in which media are placed on the media tray 103, the second media tray 120, and the third media tray 130.

As illustrated in FIG. 7, media M1, M2, and M3 can be simultaneously (collectively) placed on the first media placement surface 103a of the media tray 103, the second media placement surface 120a of the second media tray 120, and the third media placement surface 130a of the third media tray 130, respectively. When the media M1, M2, and M3 are placed on the first media placement surface 103a, the second media placement surface 120a, and the third media placement surface 130a, respectively, a feed roller and a separation roller described later first convey the medium M1 that is the lowest. The feed roller and the separation roller convey the medium M1, convey the medium M2 that is the second lowest, and then convey the medium M3 that is the highest.

In this manner, the medium conveying apparatus 100 automatically and successively conveys the media placed on the first media placement surface 103a, the second media placement surface 120a, and the third media placement surface 130a. The user can simultaneously set media having different sizes and causes the medium conveying apparatus 100 to scan the media in one batch. Thus, the medium conveying apparatus 100 can enhance user convenience.

When the third media tray 130 swings to the highest position, the leading end of the medium M3 (indicated by the thick broken line) on the third media placement surface 130a contacts the lower face 123sd of the restricting portion 123s. Since the lower face 123sd of the restricting portion 123s is inclined down toward the downstream side, the medium M3 conveyed from the third media placement surface 130a contacts the lower face 123sd of the restricting portion 123s and is then conveyed along the lower face 123sd to the medium conveying path inside the apparatus.

The second media tray 120 restricts the floating of the medium M1 placed on the first media placement surface 103a. The third media tray 130 restricts the floating of the medium M2 placed on the second media placement surface 120a. Accordingly, even when a folded or bent medium is placed, the medium conveying apparatus 100 can prevent the medium from falling forward (to the front side of the medium conveying apparatus 100) and from falling off the media tray 103.

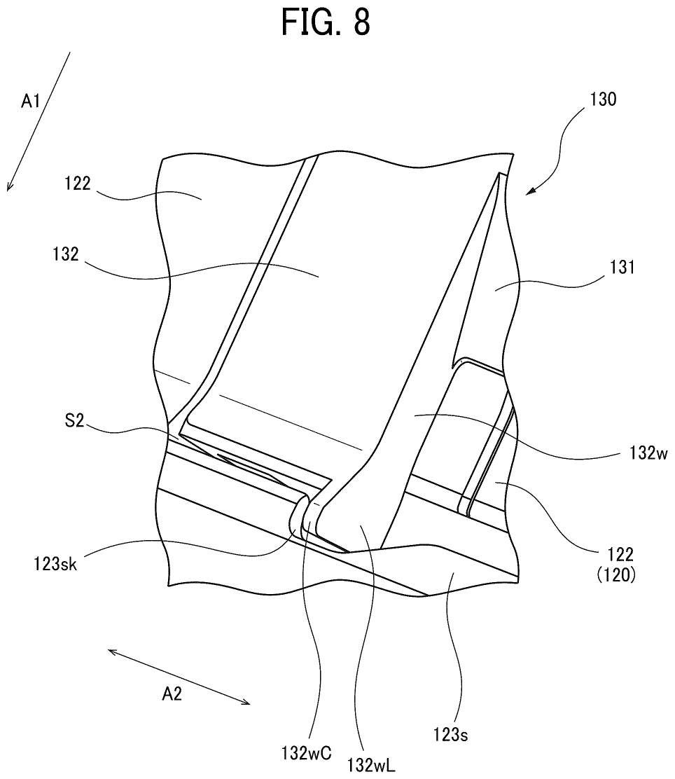

FIG. 8 is a perspective view of the third media tray 130 for explaining the overlap between the third sidewall 132w of the third media tray 130 and the restricting portion 123s.

The third sidewall 132w of the third media tray 130 includes an end portion 132wL. The end portion 132wL is located at the downstream end of the third sidewall 132w. The end portion 132wL enters the first cutout portion 123sk of the restricting portion 123s when the third media tray 130 is attached to the main body 123 of the guide body 121. When the end portion 132wL of the third sidewall 132w enters the first cutout portion 123sk, the end portion 132wL of the third sidewall 132w overlaps the restricting portion 123s when viewed in the width direction A2 intersecting the medium conveying direction A1.

Since the third sidewall 132w overlaps the restricting portion 123s when viewed in the width direction A2, the medium placed on the third media tray 130 is prevented from being caught in a clearance S2 between the arm 132 and the restricting portion 123s at the downstream end of the third media tray 130. Accordingly, the medium conveying apparatus 100 can prevent the medium from being caught in the clearance S2 and damaged. The upper end of the end portion 132wL is integral with a projection 132wC that is substantially triangular in a side view when viewed in the width direction A2.

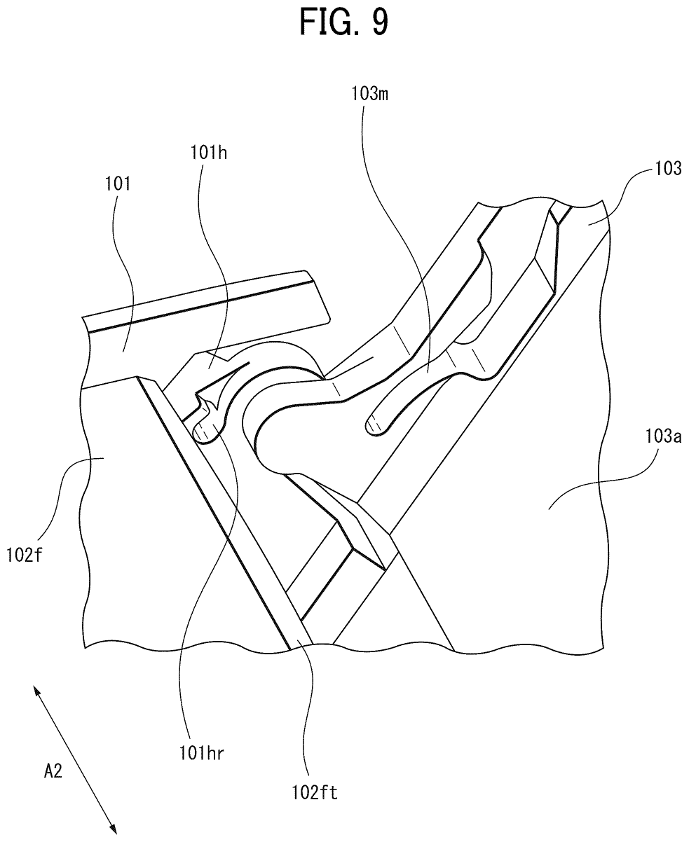

FIG. 9 is a perspective view of a hinge 101h to which the leg 124 is attached.

The hinge 101h of the lower housing 101A includes a recess 101hr. The recess 101hr is a substantially columnar bottomed hole and has a certain depth in the width direction A2. The recess 101hr is located at each end of the lower housing 101 in the width direction A2. The swing shaft 124a (FIG. 3) of the leg 124, which is the swing fulcrum of the guide body 121, is fitted into the recess 101hr.

The downstream end portion of the media tray 103 includes a slide groove 103m located near the recess 101hr of the hinge 101h. The slide groove 103m is located at each end of the media tray 103 in the width direction A2. The slide shaft 124b of the leg 124 of the guide body 121 is slidably attached to the slide groove 103m in the media tray 103.

When the swing shaft 124a is fitted into the recess 101hr and the slide shaft 124b slides along the slide groove 103m in conjunction with the swinging of the media tray 103 between the in-use position and the stored position, the guide body 121 swings. When the swing shaft 124a of the leg 124 is detached from the recess 101hr and the slide shaft 124b is detached from the slide groove 103m, the medium guide 110 is detached from the lower housing 101 and the media tray 103. In this manner, the medium guide 110 is attachable to and detachable from the media tray 103. The user can make the apparatus properly convey media different in width by setting the medium guide 110 on the media tray 103 and collectively place a large number of large-sized media on the media tray 103 by detaching the medium guide 110 from the media tray 103. The medium conveying apparatus 100 can flexibly change the mode of the media tray 103 according to the purpose of the user and can enhance user convenience.

The slide groove 103m is closer to the first media placement surface 103a (farther from the lid 102f) as the position shifts to the downstream side when the media tray 103 is at the stored position. Accordingly, the distance between the media tray 103 and the medium guide 110 is smaller when the media tray 103 is at the stored position compared with when the media tray 103 is at the in-use position. Accordingly, the medium conveying apparatus 100 can be compact when not used.

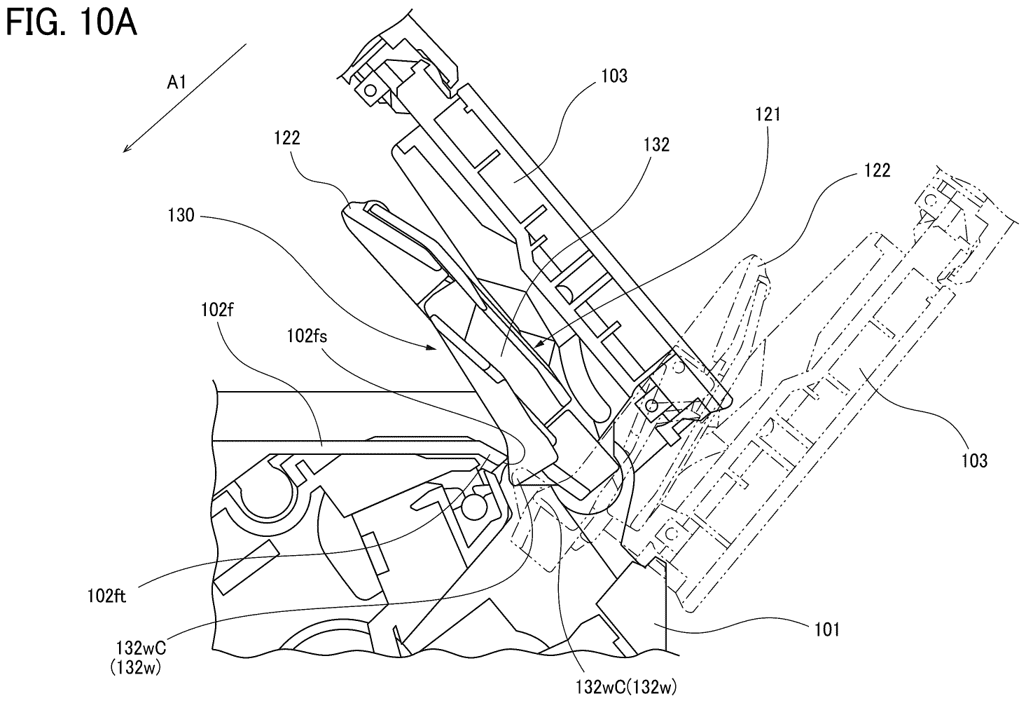

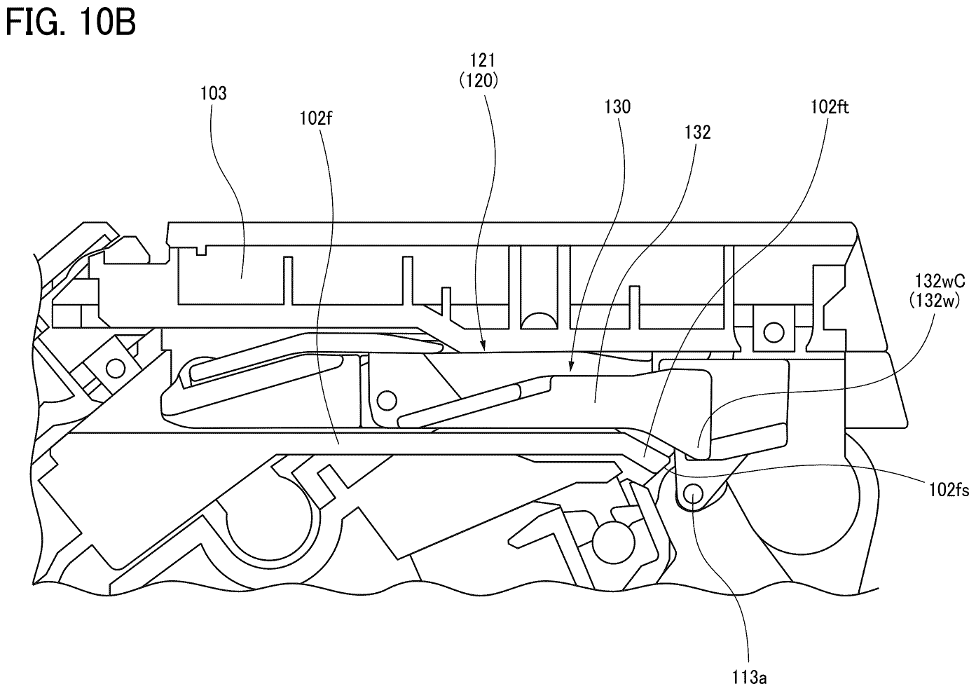

FIG. 10A is a schematic diagram illustrating the medium guide 110 being stored in conjunction with the media tray 103. FIG. 10B is a schematic diagram illustrating the medium guide 110 stored in conjunction with the media tray 103.

As illustrated in FIGS. 10A and 10B, the lid 102f of the upper housing 102 includes a contact portion 102ft. The upstream end of the contact portion 102ft is bent downward. The upstream end of the contact portion 102ft includes an end face 102fs. The end face 102fs of the contact portion 102ft is located to face the projection 132wC of the third sidewall 132w of the third media tray 130 when the media tray 103 is at the in-use position (indicated by the broken line). In other words, the length of the third media tray 130 in the medium conveying direction A1 is set such that the projection 132wC faces the end face 102fs when the third media tray 130 is attached to the guide body 121.

In this manner, when the second media tray 120 and the third media tray 130 swing in conjunction with the media tray 103, the contact portion 102ft in the upper housing 102 of the medium conveying apparatus 100 contacts the projection 132wC of the third sidewall 132w of the third media tray 130. When the media tray 103 moves from the in-use position to the stored position, the downstream end of the third media tray 130 swings forward (toward the lid 102f by its own weight). However, the downstream end of the third media tray 130 is caught by the contact portion 102ft and does not contact the upper face of the lid 102f of the third media tray 130. This prevents the third media tray 130 from being stuck between the media tray 103 and the lid 102f and allows the media tray 103 to be stored. Thus, the user can easily store the media tray 103.

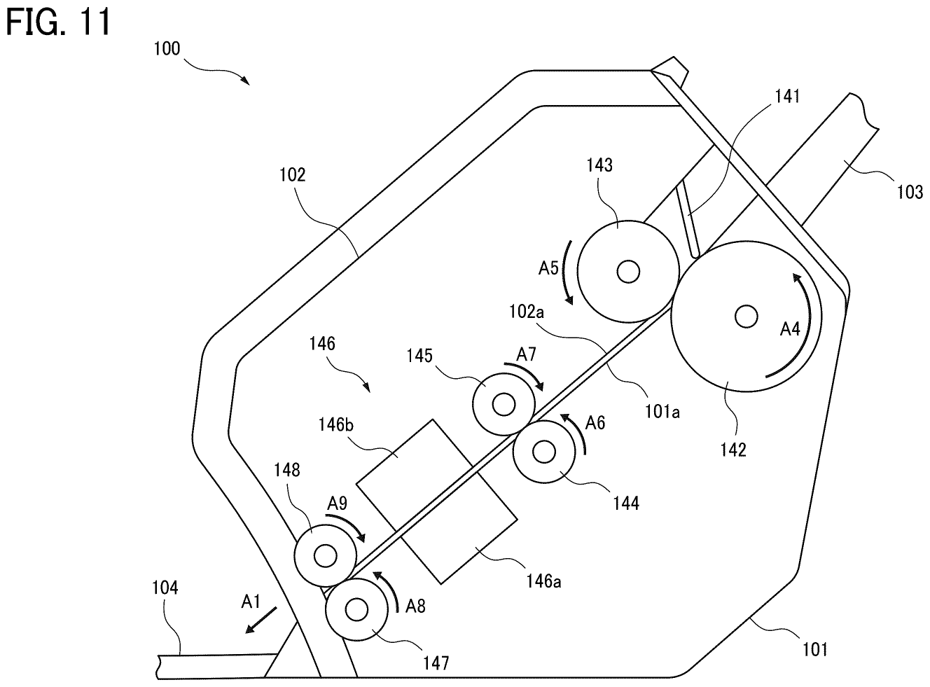

FIG. 11 is a diagram for explaining the medium conveying path inside the medium conveying apparatus 100.

The medium conveying apparatus 100 includes a media sensor 141, a feed roller 142, a separation roller 143, a first conveyance roller 144, a second conveyance roller 145, an imaging device 146 including an image sensor, a first ejection roller 147, and a second ejection roller 148 along the medium conveying path. The number of each roller is not limited to one, but may be two or more. When one or more of the above rollers are formed of multiple rollers, the multiple rollers are located at intervals in the width direction A2.

The medium conveying apparatus 100 has a so-called straight path. The upper face of the lower housing 101 forms a lower guide face 101a of the medium conveying path, and the lower face of the upper housing 102 forms an upper guide face 102a of the medium conveying path. The area (path) sandwiched by the lower guide face 101a and the upper guide face 102a is an example of the medium conveying path that guides media.

The media sensor 141 is located upstream from the feed roller 142 and the separation roller 143. The media sensor 141 includes a contact sensor and detects whether a medium is placed on the media tray 103. The media sensor 141 generates a media signal having a value that changes depending on whether a medium is placed on the media tray 103 and outputs the generated media signal. The media sensor 141 is not limited to a contact sensor but may be any sensor, such as an optical sensor, to detect the presence of a medium.

The feed roller 142 and the separation roller 143 are located upstream from the first conveyance roller 144 and the second conveyance roller 145 in the medium conveying direction A1. The feed roller 142 is in the lower housing 101, separates the media on the media tray 103 one by one from the bottom, and sequentially feeds the media. The separation roller 143 is a so-called brake roller or retard roller, located in the upper housing 102, and faces the feed roller 142. The separation roller 143 is rotatable or is stoppable in the direction indicated by arrow A5 opposite to the rotation direction for feeding a medium (i.e., the medium feeding direction). Note that the separation roller 143 is rotatable or stoppable in the medium feeding direction. Instead of the separation roller 143, a separation pad may be used.

The first conveyance roller 144 and the second conveyance roller 145 are located downstream from the feed roller 142 and the separation roller 143 and face each other. The first conveyance roller 144 and the second conveyance roller 145 convey the medium fed and separated by the feed roller 142 and the separation roller 143 to the imaging device 146.

The imaging device 146 is located downstream from the first conveyance roller 144 and the second conveyance roller 145 and upstream from the first ejection roller 147 and the second ejection roller 148. The imaging device 146 includes a first imaging device 146a and a second imaging device 146b. The first imaging device 146a and the second imaging device 146b are located near the medium conveying path and face each other across the medium conveying path.

The first imaging device 146a includes a unity-magnification contact image sensor (CIS) as a line sensor. The CIS includes complementary metal oxide semiconductor (CMOS) imaging elements aligned linearly in the main scanning direction. The first imaging device 146a further includes a lens that forms an image on the imaging elements and an analog-to-digital (A/D) converter. The A/D converter amplifies the electrical signals output from the imaging elements and performs analog-to-digital (A/D) conversion. The first imaging device 146a images the front side of the medium conveyed, generates an input image, and outputs the input image.

Similarly, the second imaging device 146b includes a unity-magnification CIS including CMOS imaging elements arranged linearly in the main scanning direction, as a line sensor. The second imaging device 146b further includes a lens that forms an image on the imaging elements and an A/D converter. The A/D converter amplifies the electrical signals output from the imaging elements and performs A/D conversion. The second imaging device 146b images the back side of the medium conveyed, generates an input image, and outputs the input image.

Alternatively, the medium conveying apparatus 100 may include either the first imaging device 146a or the second imaging device 146b to read only one side of the media. Further, the line sensor may include, instead of the unity-magnification CIS including CMOS imaging elements, a unity-magnification CIS including charge-coupled device (CCD) imaging elements. Alternatively, a reduction-optical type line sensor including CMOS or CCD imaging elements may be used.

The first ejection roller 147 and the second ejection roller 148, which are located downstream from the imaging device 146 and face each other, eject the medium conveyed by the first conveyance roller 144 and the second conveyance roller 145 onto the ejection tray 104.

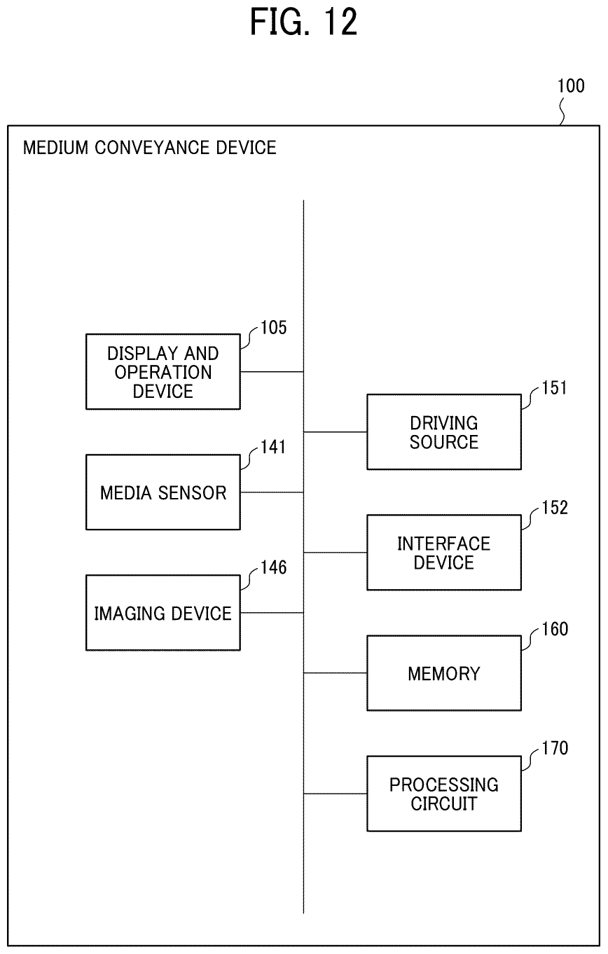

The medium placed on the media tray 103, the second media tray 120, and the third media tray 130 are conveyed between the lower guide face 101a and the upper guide face 102a in the medium conveying direction A1 as the feed roller 142 rotates in the direction indicated by arrow A4 in FIG. 11. The separation roller 143 rotates or is kept stationary in the direction indicated by arrow A5 in FIG. 12 when conveying the medium. When two or more media are placed on the media tray 103, the second media tray 120, and the third media tray 130, only the medium in contact with the feed roller 142 is separated from the rest of the media by the action of the feed roller 142 and the separation roller 143. This operation prevents the feeding of a medium other than the separated medium (prevention of multi-feed).

The medium is fed between the first conveyance roller 144 and the second conveyance roller 145 while being guided by the lower guide face 101a and the upper guide face 102a. The medium is fed between the first imaging device 146a and the second imaging device 146b as the first conveyance roller 144 and the second conveyance roller 145 rotate in the directions indicated by arrows A6 and A7 in FIG. 12, respectively. The medium read by the imaging device 146 is ejected onto the ejection tray 104 as the first ejection roller 147 and the second ejection roller 148 rotate in the directions indicated by arrows A8 and A9 in FIG. 12, respectively.

FIG. 12 is a block diagram illustrating a schematic configuration of the medium conveying apparatus 100.

The medium conveying apparatus 100 further includes a driving source 151, an interface device 152, a memory 160, and a processing circuit 170 in addition to the above-described components.

The driving source 151 includes one or more motors. In response to a control signal from the processing circuit 170, the driving source 151 rotates the feed roller 142, the separation roller 143, the first conveyance roller 144, the second conveyance roller 145, the first ejection roller 147, and/or the second ejection roller 148 to convey a medium.

The interface device 152 includes an interface circuit compatible with a serial bus such as a universal serial bus (USB). The interface device 152 is electrically connected to an information processing apparatus (e.g., a personal computer or a mobile information processing terminal) to transmit and receive a read image and various kinds of information to and from the information processing apparatus. The interface device 152 may be substituted by a communication device that includes an antenna to transmit and receive wireless signals and a wireless communication interface device to transmit and receive signals through a wireless communication line according to a predetermined communication protocol. The predetermined communication protocol is, for example, a wireless local area network (LAN) communication protocol.

The memory 160 includes memories such as a random-access memory (RAM) and a read-only memory (ROM), a fixed disk device such as a hard disk, or a portable memory such as a flexible disk or an optical disk. The memory 160 stores, for example, computer programs, databases, and tables used for various processes performed by the medium conveying apparatus 100. The computer programs may be installed in the memory 160 from a computer-readable portable recording medium using, for example, a setup program. The portable recording medium is, for example, a compact disc read-only memory (CD-ROM) or a digital versatile disc read-only memory (DVD-ROM). The computer programs may be distributed from, for example, a server and installed in the memory 160.

The processing circuit 170 operates according to a program prestored in the memory 160. The processing circuit 170 is, for example, a central processing unit (CPU). Alternatively, a digital signal processor (DSP), a large-scale integration (LSI), an application-specific integrated circuit (ASIC), a field-programmable gate array (FPGA), etc., may be used as the processing circuit 170.

The processing circuit 170 is connected to the display and operation device 105, the media sensor 141, the imaging device 146, the driving source 151, the interface device 152, the memory 160, etc., and controls these devices. The processing circuit 170 controls operations such as driving the driving source 151 and imaging with the imaging device 146 based on the media signal received from the media sensor 141 to obtain an input image from the imaging device 146. Then, the processing circuit 170 transmits the input image to the information processing apparatus via the interface device 152.

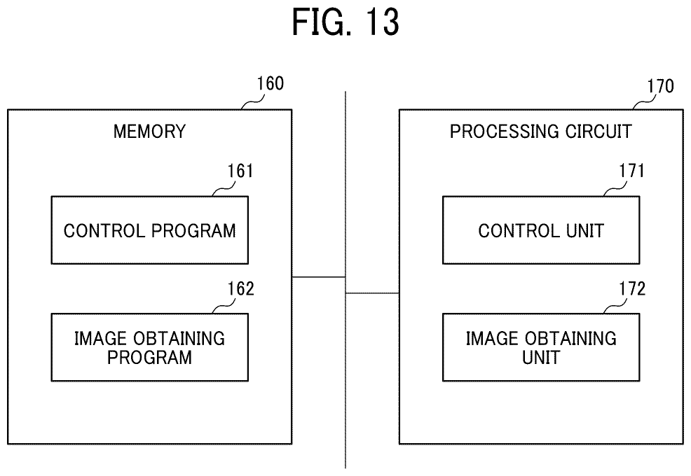

FIG. 13 is a block diagram illustrating a schematic configuration of the memory 160 and the processing circuit 170.

As illustrated in FIG. 13, the memory 160 stores a control program 161 and an image obtaining program 162. These programs are functional modules implemented by software that operates on the processor. The processing circuit 170 reads the programs from the memory 160 and operates according to the read programs, thereby functioning as a control unit 171 and an image obtaining unit 172.

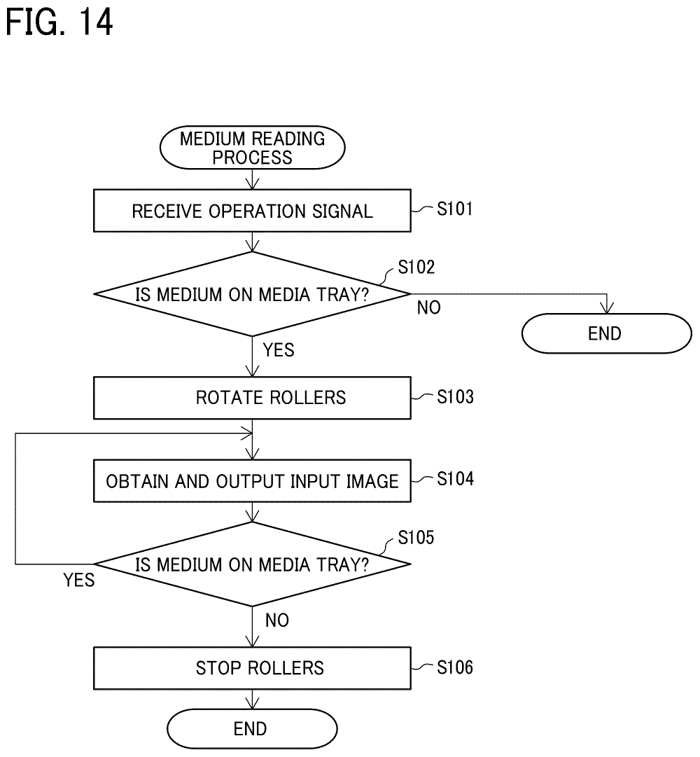

FIG. 14 is a flowchart of a medium reading process performed by the medium conveying apparatus 100.

The medium reading process performed by the medium conveying apparatus 100 is described below with reference to the flowchart in FIG. 14. The process described below is executed, for example, by the processing circuit 170 in cooperation with the components of the medium conveying apparatus 100 based on the program prestored in the memory 160.

In step S101, the control unit 171 stands by until an operation signal instructing the reading of a medium is received from the display and operation device 105 or an information processing apparatus via the interface device 152. The operation signal is output when a user inputs an instruction to read the medium using the display and operation device 105 or the information processing apparatus.

In step S102, the control unit 171 obtains a media signal from the media sensor 141 and determines whether a medium is placed on any of the media tray 103, the second media tray 120, and the third media tray 130 based on the obtained media signal. The control unit 171 ends the series of steps when no medium is placed on the media tray 103, the second media tray 120, and the third media tray 130.

By contrast, when a medium is placed on any of the media tray 103, the second media tray 120, and the third media tray 130 (Yes in step S102), the control unit 171 controls the feed roller 142, the separation roller 143, the first conveyance roller 144, the second conveyance roller 145, the first ejection roller 147, and/or the second ejection roller 148 to rotate in step S103. The control unit 171 drives the driving source 151 to rotate the rollers to feed and convey the medium.

In step S104, the image obtaining unit 172 controls the imaging device 146 to image the medium, obtains an input image from the imaging device 146, and transmits the input image to the information processing apparatus via the interface device 152 to output the input image.

In step S105, the control unit 171 determines whether a medium remains on any of the media tray 103, the second media tray 120, and the third media tray 130 based on the media signal received from the media sensor 141. When a medium remains on any of the media trays, the control unit 171 returns the process to step S104 and repeats the operations of steps S104 and S105.

By contrast, when no medium remains on any of the media tray 103, the second media tray 120, and the third media tray 130 (No in step S105), the control unit 171 stops the feed roller 142, the separation roller 143, the first conveyance roller 144, the second conveyance roller 145, the first ejection roller 147, and/or the second ejection roller 148 in step S106. The control unit 171 controls the driving source 151 to stop the rollers and ends the series of steps.

As described above in detail, in the medium conveying apparatus 100, the third media tray 130 is swingable downward relative to the second media tray 120 in accordance with the amount of media placed on the second media placement surface 120a. Accordingly, in the medium conveying apparatus 100, even when a large amount of media is placed on the first media placement surface 103a, a certain amount of media can be placed on the second media placement surface 120a. Thus, the medium conveying apparatus 100 can properly convey various media different in width.

### Other Embodiments

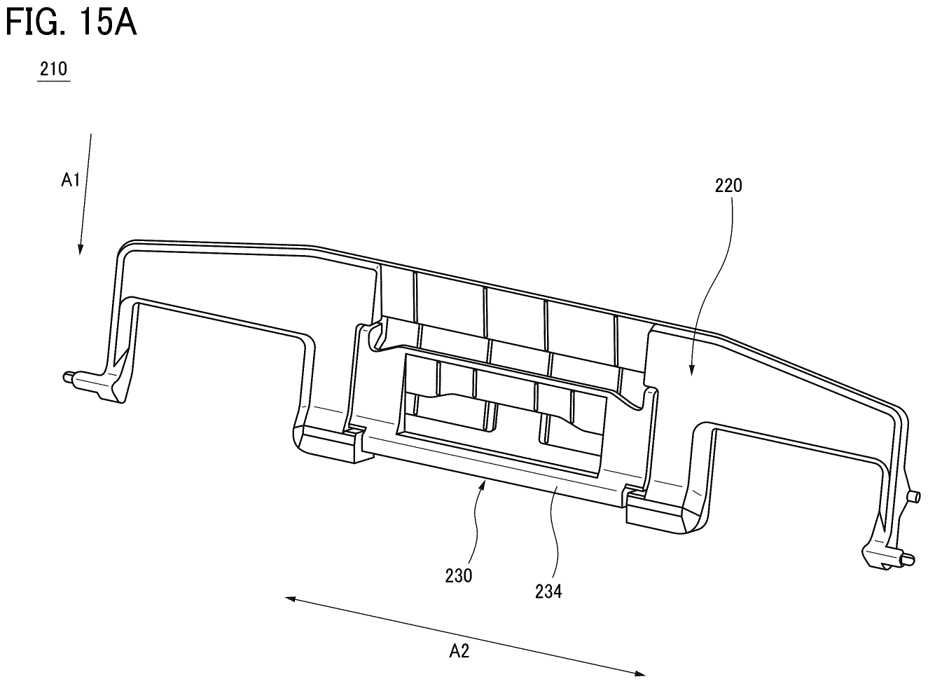

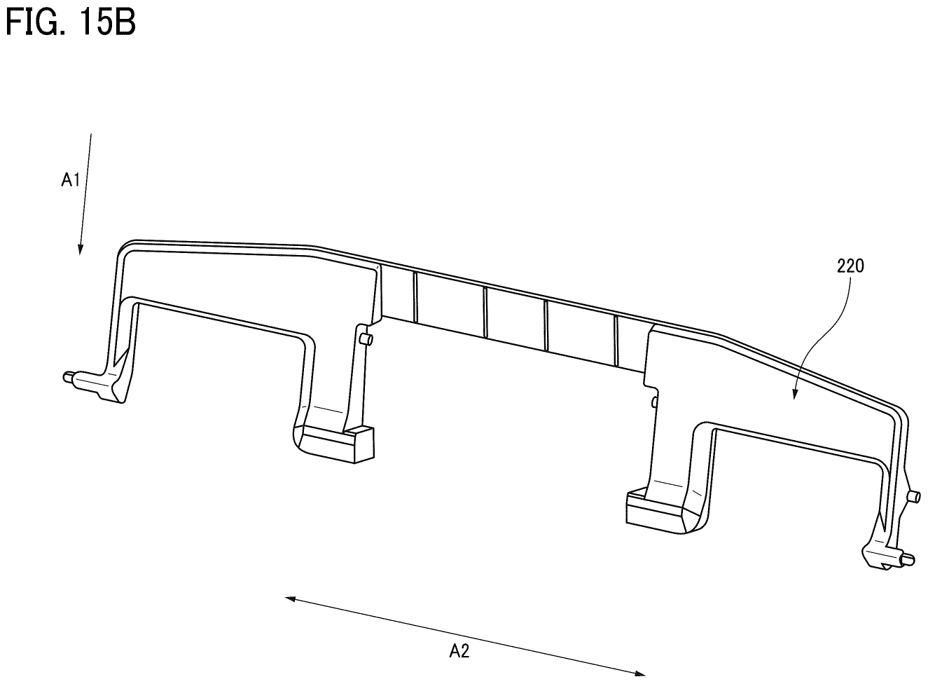

FIG. 15A is a perspective view of a medium guide 210 according to another embodiment, as viewed from obliquely above. FIG. 15B is a perspective view of a guide body of the medium guide 210 illustrated in FIG. 15A, as viewed from obliquely above.

The medium conveying apparatus according to the present embodiment is similar in configuration and function to the medium conveying apparatus 100. However, the medium conveying apparatus according to the present embodiment includes the medium guide 210 instead of the medium guide 110. The medium guide 210 includes a second media tray 220 and a third media tray 230. The second media tray 220 and the third media tray 230 are similar in configuration and function to the second media tray 120 and the third media tray 130, respectively. However, the second media tray 220 does not include the restricting portion 123s, and the third media tray 230 includes a restricting portion 234. The restricting portion 234 is similar in configuration and function to the restricting portion 123s. The restricting portion 234 is located downstream from the third media tray 230 and in a central portion in the width direction A2. The restricting portion 234 guides the medium placed on the third media placement surface 130a downstream while restricting the medium from floating.

Accordingly, the third media tray 230 can properly guide the medium placed on the third media placement surface 130a downstream.

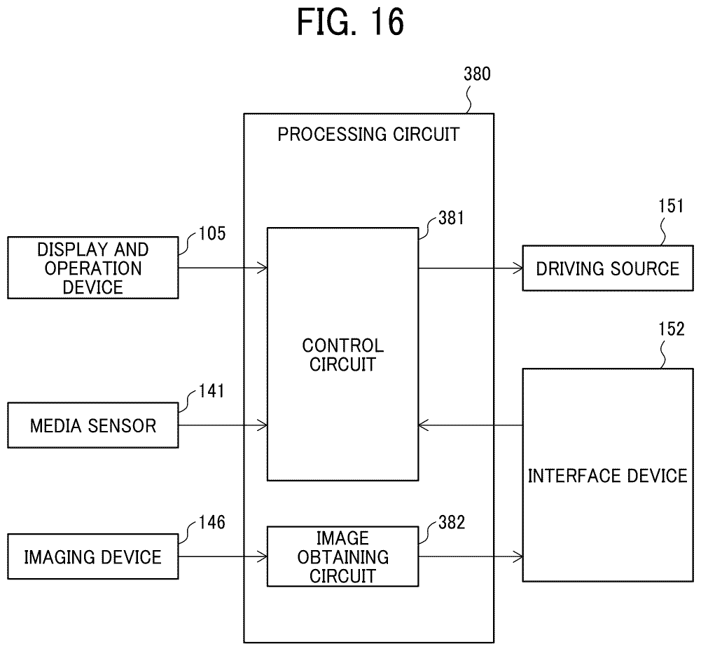

FIG. 16 is a schematic block diagram illustrating a schematic configuration of another processing circuit.

FIG. 16 illustrates a processing circuit 380 used in place of the processing circuit 170 of the medium conveying apparatus 100. The processing circuit 380 executes the medium reading process, etc., in place of the processing circuit 170. The processing circuit 380 includes a control circuit 381 and an image obtaining circuit 382. These circuits may be implemented by independent integrated circuits, microprocessors, firmware, or a combination thereof.

The control circuit 381 is an example of circuitry and functions like the control unit 171. The control circuit 381 receives operation signals from the display and operation device 105 or the interface device 152 and receives the media signal from the media sensor 141. The control circuit 381 controls the driving source 151 based on the received information.

The image obtaining circuit 382 is an example of the circuitry and functions like the image obtaining unit 172. The image obtaining circuit 382 obtains an input image from the imaging device 146 and outputs the input image to the interface device 152.

The medium conveying apparatus can properly convey media as described above in detail, also when the processing circuit 380 is used.

Embodiments of the present disclosure are not limited to the above-described embodiments. For example, the third media tray may not have the third media placement surface and may be used to simply hold the medium placed on the second media tray.

Further, the medium conveying path may be a so-called U-turn path, and the medium conveying apparatus may feed and convey media placed on the media tray sequentially from the top and eject the medium to the ejection tray. In this configuration, the separation roller is located below the feed roller to face the feed roller.

The medium conveying apparatus may include an image forming device instead of or in addition to the imaging device 146. The image forming device employs, for example, an inkjet printing method or a laser printing method, is located at the position corresponding to the position of the imaging device 146, and forms an image (prints information) on a medium conveyed. The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A medium conveying apparatus comprising:
a first media tray including a first media placement surface;
a second media tray located above the first media tray and including a second media placement surface;
a third media tray located above the second media tray and including a third media placement surface, wherein
a width of the second media placement surface in an intersecting direction intersecting a medium conveying direction and a width of the third media placement surface in the intersecting direction are smaller than a width of the first media placement surface in the intersecting direction, and
the third media tray is swingable relative to the second media tray in accordance with an amount of media placed on the second media placement surface.

2. The medium conveying apparatus according to claim 1,
wherein the second media tray is swingable relative to the first media tray in accordance with an amount of media placed on the first media placement surface.

3. The medium conveying apparatus according to claim 1,
wherein a swing fulcrum of the third media tray is located at an upstream end of the third media tray in the medium conveying direction.

4. The medium conveying apparatus according to claim 3,
wherein the second media tray includes a stopper to restrict swinging of a downstream end of the third media tray in the medium conveying direction.

5. The medium conveying apparatus according to claim 1,
wherein a swing fulcrum of the third media tray is located outer than the second media placement surface in the intersecting direction intersecting the medium conveying direction.

6. The medium conveying apparatus according to claim 1,
wherein the third media tray includes a wall located at an end of the third media placement surface in the intersecting direction intersecting the medium conveying direction.

7. The medium conveying apparatus according to claim 6, wherein
the second media tray further includes a restricting portion to restrict floating of a medium placed on the third media placement surface, and
the wall overlaps the restricting portion when viewed in the intersecting direction intersecting the medium conveying direction.

8. The medium conveying apparatus according to claim 1,
wherein the third media tray further includes a restricting portion to restrict floating of a medium placed on the third media placement surface.

9. The medium conveying apparatus according to claim 1, further comprising a contact portion located in a housing of the medium conveying apparatus,
wherein the contact portion contacts the third media tray when the second media tray and the third media tray swing in conjunction with the first media tray.

10. The medium conveying apparatus according to claim 2,
wherein the second media tray is swingable downward from a position of the second media tray in a state where no medium is placed on the first media placement surface and the third media placement surface.

11. The medium conveying apparatus according to claim 2,
wherein the second media tray swings downward when an amount of media placed on the second media placement surface is equal to or more than a predetermined amount.
